(19) United States
(12) Patent Application Publication
(10) Pub. No.: US 2015/0053061 A1
(43) Pub. Date: Feb. 26, 2015

(54) Guitar Cradle

(71) Applicant: Santo Joseph Coglitore, North Syracuse, NY (US)

(72) Inventor: Santo Joseph Coglitore, North Syracuse, NY (US)

(21) Appl. No.: 14/460,393

(22) Filed: Aug. 15, 2014

Related U.S. Application Data
(60) Provisional application No. 61/869,931, filed on Aug. 26, 2013.
(60) Provisional application No. 61/873,573, filed on Sep. 4, 2013.

(51) Int. Cl. G10G 5/00

(52) U.S. Cl. CPC G10G 5/00
USPC 84/327

(57) ABSTRACT

The guitar cradle provides a method for holding and supporting a guitar when using a belt secured around the waist while in a standing position. The guitar strap buttons that are standard on most guitars are positioned so as to be used with a traditional guitar strap and do not provide adequate support when using a belt secured around the waist to hold and support a guitar. The guitar cradle provides support for a guitar that uses a belt secured to the waist by fitting securely to the underside of the guitar body without any modifications being necessary to the guitar and provides a strap button or other type connector that allows for securing the guitar to the belt worn around the waist.

### CROSS-REFERENCE TO RELATED APPLICATIONS

This application claims the benefit of U.S. Provisional Application No. 61/869,931 filed Aug. 26, 2013 and U.S. Provisional Application No. 61/873,573 filed Sep. 4, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to a guitar strap and more specifically to a support apparatus used to assist in redistributing the weight of a guitar from the shoulder area to the waist area of a user.

Very often, guitars are played while the user is in a standing position. The traditional and most common method of holding the guitar in place while standing is to use a strap that is passed over the shoulder and across the neck while being secured to strap buttons that are typically built in to the guitar when manufactured. When using this method, all of the guitars weight is supported by the shoulder and neck area. This has a tendency to cause discomfort, pain, and sometimes injury to the shoulder or neck area, especially after long term use.

An alternative method of holding a guitar while in a standing position is to use a belt that is secured around the waist. This method allows the guitars weight to be redistributed from the shoulder to the waist thereby relieving pressure from the shoulder and neck area. The standard positioning of the guitar strap buttons is not adequate for supporting a guitar from the waist. The prior art that uses a waist belt for this purpose, requires either that modifications be made to the guitar or requires the use of various types of straps secured around the body of the guitar to attach and support the guitar. Both of these methods are undesirable for the following reasons: 1) Modifications to the guitar require drilling holes and using hooks or additional strap buttons to attach and secure the guitar, which can adversely affect the resale value of the instrument and 2) Using straps wrapped around the guitars body can adversely affect the appearance of the guitar.

This invention provides a method of securing a guitar to a belt secured to the waist so that no modifications are necessary to the guitar, while being low profile as to not negatively affect the appearance of the guitar.

### BRIEF SUMMARY OF THE INVENTION

This invention uses a cradle support apparatus that fits securely to the underside of the body of the guitar. The cradle can be made of metal, wood, plastic, or any other material rigid enough to support the weight of a guitar. The cradle can be custom shaped to fit the contour of the underside of the body of a specific guitar or can be made to be adjustable to fit a variety of guitar body shapes and widths. The cradle would also be coated with a silicone rubber or similar material to protect the guitar finish and provide a tacky surface to help prevent slippage. The cradle would also contain a connector such as a guitar strap button or other type of connector that would allow the cradle to be attached to the belt that is secured around the waist of a user.

### BRIEF DESCRIPTION OF THE SEVERAL VIEWS OF THE DRAWING

The accompanying drawings include the following:

FIG. 1 is a top view of the cradle showing the area that makes contact with the guitar body.

FIG. 2 is a cross-sectional view showing the position of the cradle strap button.

FIG. 3 is a bottom view of the cradle showing the screw head and slot used for adjusting the cradle width.

FIG. 4 is a view showing the positioning of the cradle on a typical guitar from the back side of the guitar body.

FIG. 5 is a view showing the positioning of the cradle on a typical guitar from the front side of the guitar body.

### DETAILED DESCRIPTION OF THE INVENTION

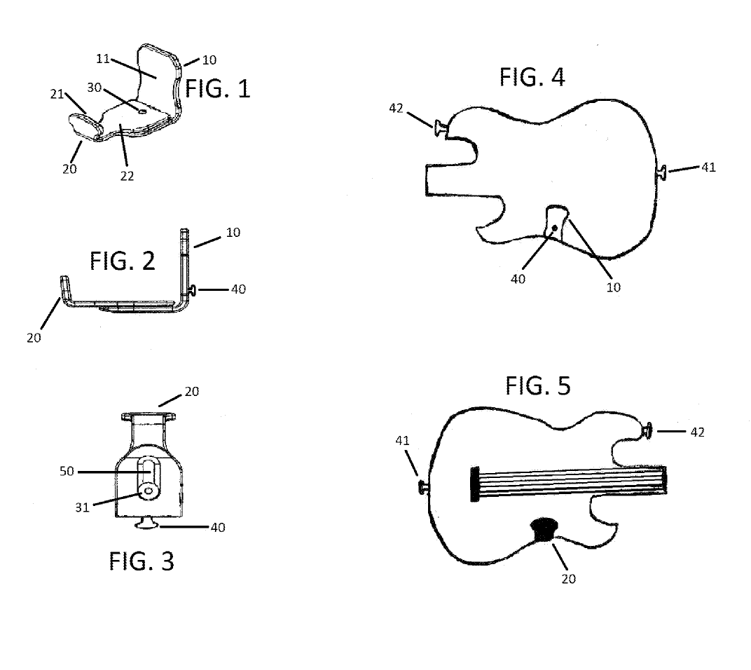

The guitar cradle is constructed of a rigid material such as metal, wood, or plastic and is shaped to fit and secure firmly to the middle underside portion of the body of the guitar. FIG. 1 shows the top or inside portion of the cradle where the guitar body makes contact with the cradle. The cradle body is constructed of two parts that slide together; the back side (10) and front side (20). The inside portions of the cradle shown in FIGS. 1: (11), (21), and (22) are coated with silicone rubber or other similar material to protect the guitar finish and also to provide a tacky surface so as to clasp the guitar tightly and prevent slippage. FIG. 1 also shows a threaded screw hole (30) that supports the screw (31) shown in FIG. 3. Attached to the back side of the cradle is a strap button (40) shown in FIG. 2 and FIG. 3. The strap button (40) attaches to a strap that is secured to a waist belt. FIG. 3 shows a slot (50) that allows the two sides (10) and (20) to slide back and forth to allow the cradle to be adjusted to fit the width of the guitar body. FIG. 4 shows the position of the back side of the cradle (10) when attached to the guitar body. The cradle strap button (40) can also be seen in FIG. 4. FIG. 5 shows the position of the front side of the cradle (20) when attached to the guitar body. This view also shows the built in guitar strap buttons (41) and (42) that would normally be used with a shoulder strap to support the guitar.

The invention claimed is:

1. An apparatus securable to the underside of the body of a guitar for the purpose of supporting the guitar of an operator while said operator is standing, said apparatus comprising: a cradle or clasp constructed of metal, wood, plastic, or any material rigid enough to support the weight of the guitar, said cradle or clasp is constructed to either custom fit or be adjustable to fit the contour of the underside including lower back side and front side portions of the body of the guitar without any modifications being necessary to the guitar and said cradle or clasp containing a connecting device that would allow the cradle or clasp to attach to and be suspended from a belt that is secured about the waist of an operator.
